(19) United States
(12) Patent Application Publication
(10) Pub. No.: US 2010/0050208 A1
(43) Pub. Date: Feb. 25, 2010

(54) METHOD AND APPARATUS FOR PROVIDING CHANNEL LIST AND SOURCE LIST INFORMATION IN IMAGE DISPLAY SYSTEM

(75) Inventors: Seung-dong Yu, Osan-si (KR); Chang-seog Ko, Hwaseong-si (KR); Yoon-hoe Gu, Gwacheon-si (KR); Jung-A Kim, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/412,034

(22) Filed: Mar. 26, 2009

(30) Foreign Application Priority Data
Aug. 20, 2008 (KR) 10-2008-0081370

(51) Int. Cl. H04N 5/445

(52) U.S. Cl. 725/43; 725/56; 725/59

(57) ABSTRACT

A method of providing a channel list in an image display system includes receiving a signal mapped to a channel list from an external device; displaying a channel list including one or more channels in response to the received signal; selecting a first channel from the channels included in the channel list; and displaying a tuned first screen of the selected first channel and a second screen, wherein additional information about the first channel is displayed in the second screen.

### CROSS-REFERENCE TO RELATED PATENT APPLICATIONS

This application claims priority from Korean Patent Application No. 10-2008-0081370, filed on Aug. 20, 2008 in the Korean Intellectual Property Office, the disclosure of which is incorporated herein in its entirety by reference.

### BACKGROUND OF THE INVENTION

1. Field of the Invention

Methods and apparatuses consistent with the present invention relate to providing a channel list and a source list in an image display system.

2. Description of the Related Art

With digital broadcasting developments, additional data for providing a variety of services related to contents as well as video and audio data of contents can be transmitted.

In addition, as broadcasting channels are diversified due to the emergence of many multi system operators (MSO), the number of channels that can be viewed in digital broadcasting has rapidly increased. Thus, a method of efficiently managing a channel list among many channels by reflecting a user's preference is needed. In this case, a method of constituting a screen of the channel list by using transmitted additional data is also needed.

### SUMMARY OF THE INVENTION

The present invention provides a method and apparatus for providing a channel list and a source list in an image display system.

The present invention also provides a computer readable recording medium having recorded thereon a program for executing the method.

According to an aspect of the present invention, there is provided a method of providing a channel list in an image display system, the method including: receiving a signal mapped to a channel list from an external device; displaying a channel list including at least one or more favorite channels in response to the received signal; selecting a first channel from the at least one or more favorite channels displayed in the channel list; and displaying a tuned first screen of the selected first channel and a second screen, wherein additional information about the first channel is displayed in the second screen.

The additional information displayed in the second screen may be updated in real-time or periodically from an electronic program guide (EPG).

The displaying of the channel list may include displaying a third screen in which additional information about a second channel that is being currently displayed in the image display system is displayed.

The at least one or more favorite channels included in the channel list may be constituted in a circular linked list.

The selecting of the first channel may include selecting the first channel by moving a highlighted portion on the at least one or more favorite channels included in the channel list.

The channel list may include at least one of a channel number and a channel name, and the additional information may include at least one of a program name, a program running time, and a program description.

The program running time included in the additional information may be indicated in a bar shape.

A screen of the channel list and the additional information may disappear from a screen of the image display system after a predetermined time.

According to another aspect of the present invention, there is provided a method of providing a source list in an image display system, the method including: receiving a signal mapped to a source list from an external device; displaying a source list including at least one or more input devices that are currently connected to an image display system, in response to the received signal; selecting a first input device from the at least one or more input devices displayed in the source list; and displaying a tuned first screen of the selected first input device and a second screen, wherein additional information about the first input device is displayed in the second screen.

The additional information displayed in the source list or in the second screen may be updated in real-time or periodically from at least one or more input devices that are currently connected to the image display system.

The displaying of the source list may include displaying a third screen in which additional information about a second device that is being currently displayed in the image display system is displayed.

The at least one or more input devices included in the source list may be constituted in a circular linked list.

The selecting of the first input device may include selecting the first input device by moving a highlighted portion on the at least one or more input devices included in the source list.

The source list may include at least one of a connected terminal name and an input device name, and the additional information may include at least one of a connected terminal name, an input device name, a time at which a plurality of input devices are connected, a resolution of an input device, and a bit rate of an input device.

A screen of the source list and the additional information may disappear from a screen of the image display system after a predetermined time.

According to another aspect of the present invention, there is provided an apparatus for providing a channel list in an image display system, the apparatus including: a signal receiving unit receiving a signal mapped to a channel list from an external device; a channel list managing unit displaying a channel list including at least one or more favorite channels according to the received signal; a channel selecting unit selecting a first channel from the at least one or more favorite channels displayed in the channel list; and an output unit displaying a tuned first screen of the selected first channel and a second screen, wherein additional information about the first channel is displayed in the second screen.

According to another aspect of the present invention, there is provided an apparatus for providing a source list in an image display system, the apparatus including: a signal receiving unit receiving a signal mapped to a source list from an external device; a source list managing unit displaying a source list including at least one or more input devices that are currently connected to an image display system, in response to the received signal; an input device selecting unit selecting a first input device from the at least one or more input devices displayed in the source list; and an output unit displaying a tuned first screen of the selected first input device and a second screen, wherein additional information about the first input device is displayed in the second screen.

According to another aspect of the present invention, there is provided a computer readable recording medium having recorded thereon a program for executing the method of providing a channel list or the method of providing a source list.

### BRIEF DESCRIPTION OF THE DRAWINGS

The above and other aspects of the present invention will become more apparent by describing in detail exemplary embodiments thereof with reference to the attached drawings in which:

FIG. 1 is a flowchart illustrating a method of providing a channel list in an image display system, according to an exemplary embodiment of the present invention;

FIG. 2 illustrates the configuration of a screen including a channel list and additional information according to an exemplary embodiment of the present invention;

FIGS. 3A to 3F illustrate a screen that is shifted according to a channel selected from a channel list, according to an exemplary embodiment of the present invention;

FIG. 4 is a flowchart illustrating a method of providing a source list in an image display system, according to an exemplary embodiment of the present invention;

FIG. 5 illustrates the configuration of a screen including a source list and additional information according to an exemplary embodiment of the present invention;

FIG. 6 is a functional block diagram of an apparatus for providing a channel list in an image display system, according to an exemplary embodiment of the present invention; and

FIG. 7 is a functional block diagram of an apparatus for providing a source list in an image display system, according to an exemplary embodiment of the present invention.

### DETAILED DESCRIPTION OF EXEMPLARY EMBODIMENTS OF THE INVENTION

The attached drawings for illustrating exemplary embodiments of the present invention are referred to in order to gain a sufficient understanding of the present invention, the merits thereof, and the objectives accomplished by the implementation of the present invention.

Hereinafter, exemplary embodiments of the present invention will be described in detail with reference to the attached drawings.

FIG. 1 is a flowchart illustrating a method of providing a channel list in an image display system, according to an exemplary embodiment of the present invention.

Referring to FIG. 1, the method of providing a channel list in an image display system according to the current exemplary embodiment includes receiving a signal mapped to a channel list from an external device (operation 110), displaying a channel list including one or more favorite channels according to the received signal (operation 120), selecting a first channel from the one or more favorite channels displayed in the channel list (operation 130), and displaying a tuned first screen of the selected first channel and a second screen, wherein additional information about the first channel is displayed in the second screen (operation 140).

In operation 110, the signal mapped to the channel list is received from the external device. The signal mapped to the channel list is a signal for calling up the channel list and is mapped to perform a function of displaying the channel list in an image display system. For example, the channel list may be called up when an input signal is generated by pressing a predetermined button installed in a remote controller of a digital television (TV) or a TV.

In operation 120, the channel list including the one or more favorite channels is displayed. The channel list that has been already registered is displayed in response to a call-up command of the signal received in operation 110. The channel list may be a list in which one or more pieces of previously-registered channel information are stored and may be a favorite channel list in which user's preference is reflected. Channels may be displayed in a screen simultaneously or in a plurality of pages of the screen according to the number of channels included in the channel list. Furthermore, the channel list may be constituted in a circular data structure, such as a circular linked list, so that a user can navigate channels in the channel list in a one direction continuously.

In this case, a sub screen in which additional information about broadcasting contents of a channel that is currently being displayed is displayed, as well as the channel list may be displayed in the screen. That is, when the channel list is called up and displayed, a screen of additional information about a current channel (hereinafter, referred to as a banner screen) may be displayed with a default.

In operation 130, the first channel is selected from the one or more favorite channels displayed in the channel list. In other words, one channel to be viewed may be selected from items of channels displayed in the channel list. In this case, the current channel may be included in the channel list depending on whether channels are registered in advance in the channel list.

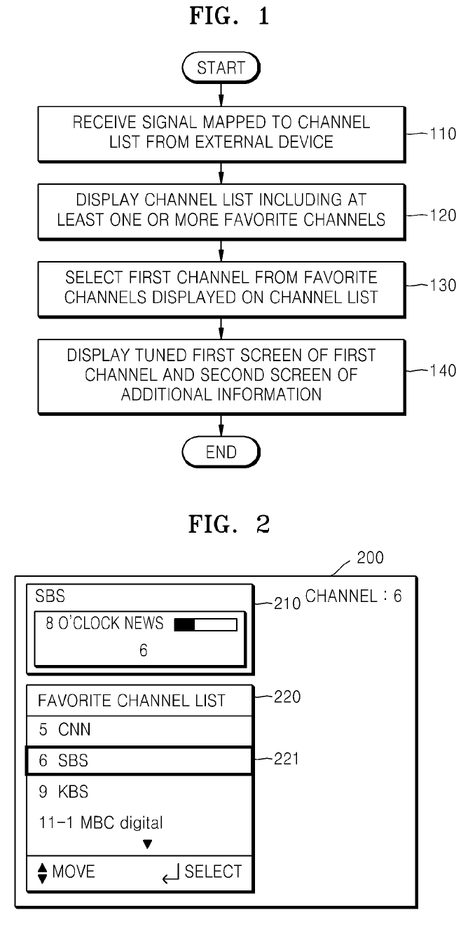

The operation of selecting one channel from the channel list may be performed by moving a highlighted portion. Hereinafter, a channel list in which a highlighted portion is used according to an exemplary embodiment of the present invention will be described with reference to FIG. 2.

In operation 140, the tuned first screen of the selected first channel and the second screen are displayed together, wherein additional information about the first channel is displayed in the second screen. The first screen is a screen of broadcasting contents that are provided in the first channel, and the second screen is a screen including the additional information related to the broadcasting contents of the first channel and may be displayed in the first screen as a sub screen in a picture in picture (PIP) format.

The additional information may be received in real-time or periodically from an electronic program guide (EPG). Furthermore, the additional information may be refreshed at a designated time according to user's selection.

In the method of providing a channel list in an image display system according to the current exemplary embodiment, the banner screen including the additional information of the registered channel is displayed in one screen together with the channel list so that a user can navigate several channels of the channel list more conveniently.

The channel list and the banner screen according to an exemplary embodiment of the present invention will now be described with reference to FIG. 2.

FIG. 2 illustrates the configuration of a screen including a channel list and additional information according to an exemplary embodiment of the present invention.

Referring to FIG. 2, broadcasting contents of channel 6 are displayed in a first screen 200 which is the entire screen. When a channel list 220 is called up by pressing a predetermined button of an image display system, the list of favorite channels that have been already registered is generated, and an additional information screen 210 of channel 6 that is being currently viewed may appear by default in a banner screen. A currently-selected channel may appear as a highlighted portion 221 in the channel list 220. The highlighted portion 221 may be generally box-shaped in a channel included in the channel list. In order to distinguish between “the currently-selected channel” and “a channel to be selected” by using the highlighted portion 221 when navigating, a two-step highlighted portion in which a font color (e.g., blue) of the currently-selected channel included in the channel list and a font color (e.g., black) of other channels become different and other channels are navigated by using the box-shaped highlighted portion 221, may be used. Thus, in FIG. 2, a font color of channel 6 that is being currently displayed may be blue, or the highlighted portion 221 that is initially displayed in the channel list may be positioned at channel 6. When channel 6 that is being currently displayed is not registered in the channel list 220, there may not be channel number having a blue font color, and the highlighted portion 221 may be indicated at a predetermined position.

The channel list 220 may include one of a channel number and a channel name, and the additional information screen 210 may include one of a program name, a program running time, and a program description.

The program running time may be indicated in a bar shape. The amount of time that has been already telecasted and the amount of time to be telecasted may be indicated in the shape of a predetermined graph and a geometrical figure.

The channel list 220 and the banner screen 210 may automatically disappear from the entire screen 200 after a predetermined time. For example, the channel list 220 may disappear after 10 seconds and the banner screen 210 may disappear after 0.5 seconds.

The configuration of the channel list 220 and the banner screen 210 is just an example and may be modified in various shapes when conditions indicating additional information of each of registered channels and a corresponding channel are satisfied.

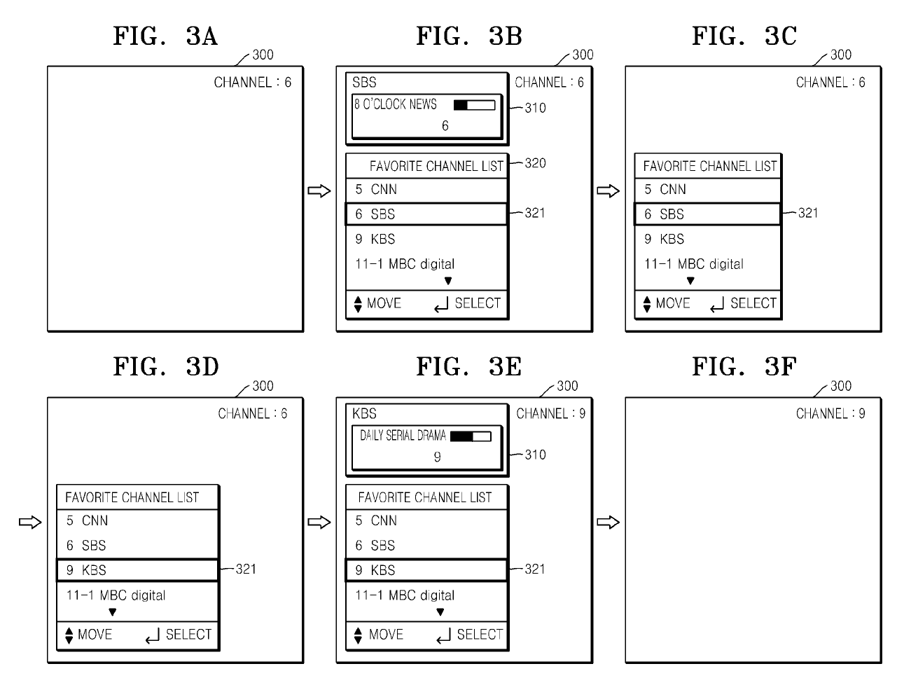

FIGS. 3A to 3F illustrate a screen that is shifted according to a channel selected from a channel list, according to an exemplary embodiment of the present invention.

When channel 6 is being viewed on the entire screen 300 of a digital TV as shown in FIG. 3A, a signal for calling up a channel list is input, and a channel list 320 and a banner screen 310 of additional information, which are the same as the screen of FIG. 2, are displayed on the entire screen 300 as shown in FIG. 3B. In this case, if no input operation is performed during a predetermined time (e.g., 0.5 seconds), the banner screen 310 of the additional information may disappear (FIG. 3C). When a user wants to change the current channel 6 into channel 9 from in the channel list 320, a highlighted portion 321 is moved to channel 9 (FIG. 3D), and a button corresponding to selection confirmation is pressed so that the current screen is converted into a screen 300 of channel 9, as illustrated in FIG. 3E, and the banner screen 310 of the additional information about channel 9 is newly displayed. Thereafter, if no input operation is performed for a predetermined time, the banner screen 310 of the additional information disappears (e.g., after 0.5 seconds), and the channel list 320 disappears (e.g., after 10 seconds), and broadcasting of channel 9 may be viewed, as illustrated in FIG. 3F. In the above procedure, other predetermined button (e.g., EXIT button) may be pressed so that the channel list 320 can disappear from the entire screen 300.

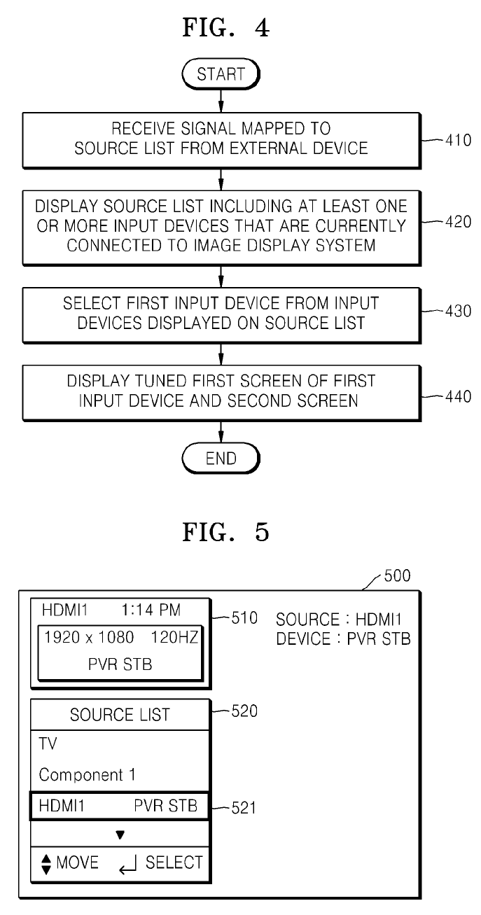

FIG. 4 is a flowchart illustrating a method of providing a source list in an image display system, according to an exemplary embodiment of the present invention.

Referring to FIG. 4, the method of providing a source list in an image display system according to the current exemplary embodiment includes receiving a signal mapped to a source list from an external device (operation 410), displaying a source list including one or more input devices that are currently connected to the image display system, according to the received signal (operation 420), selecting a first input device from the one or more input devices displayed in the source list (operation 430), and displaying a tuned first screen of the selected first input device and a second screen, wherein additional information about the first input device is displayed in the second screen (operation 440).

In operation 410, the signal mapped to the source list is received from the external device. In other words, the signal that is a signal for calling up the source list and mapped to perform a function of displaying the source list in an image display system, is received form the external device. For example, the source list may be called up when an input signal is generated by pressing a predetermined button installed at a remote controller or a TV.

In operation 420, the source list including the one or more favorite input devices (sources) is displayed. The list of input devices connected to the current image display system is displayed in response to a call-up command of the signal received in operation 410. The source list may be a list in which one or more pieces of currently-connected input device information are stored and may be updated in real-time or periodically, and the source list may be refreshed at a predetermined time according to user's selection so that a user can navigate a new input device.

Input devices (sources) may be displayed in a screen simultaneously or in a plurality of pages of the screen according to the number of input devices included in the source list. Furthermore, the source list may be constituted in a circular data structure such as a circular linked list so that a user can navigate input devices (sources) in the source list in a one direction continuously.

In this case, in addition to the source list, a sub screen in which device information of an input device that is currently being displayed or information about digital contents may be displayed. That is, when the source list is called up and displayed, a banner screen of additional information about an input device that is being currently displayed, may be displayed.

In operation 430, the first input device is selected from the one or more favorite input devices displayed in the source list. In other words, one input device to convert display may be selected from items of sources displayed in the source list. The operation of selecting one input device from the source list may be performed by moving a highlighted portion. Hereinafter, a source list in which a highlighted portion is used, according to an exemplary embodiment of the present invention will be described with reference to FIG. 5.

In operation 440, the tuned first screen of the selected first input device and the second screen are displayed together, wherein additional information about the first input device is displayed in the second screen. The first screen is a screen including digital contents that are received from the first input device, and the second screen is a screen including the additional information related to the first input device, such as a terminal name, a device name, etc., and may be displayed in the first screen in a sub screen format.

FIG. 5 illustrates the configuration of a screen including a source list and additional information according to an exemplary embodiment of the present invention.

Referring to FIG. 5, the entire screen 500 displays a source screen of “HDMI1”. In this case, when a source list 520 is called up, the list of currently-connected input devices (e.g., TV, Component 1, HDMI1, etc.) is generated, and a banner screen 510 of additional information about the source screen “HDMI1” that is being currently viewed is displayed. The name of the current device is “PVR STB”, i.e., a personal recorder set top box. A screen that is currently selected from the source list 520 may be highlighted (521).

The source list may include one of a connected terminal name (e.g., TV, AV, S-Video, Component, PC, HDMI, USB, DLNA, HDMI-CEC, etc.) and an input device name, and the banner screen 510 may include at least one of a connected terminal name, an input device name, a time at which a plurality of input devices are connected, the resolution of an input device, and a bit rate of an input device.

The source list 520 and the banner screen 510 may disappear from the entire screen 500 of the image display system after a predetermined time, and the source list 520 may disappear from the entire screen 500 by pressing other predetermined button (e.g., EXIT button).

The operation of converting a screen of input devices by using the source list may be performed in the same manner as shown in FIG. 3.

The screen configuration of the source list 520 is just an example and may be modified in various shapes when conditions indicating additional information of connected input devices and a corresponding input device are satisfied.

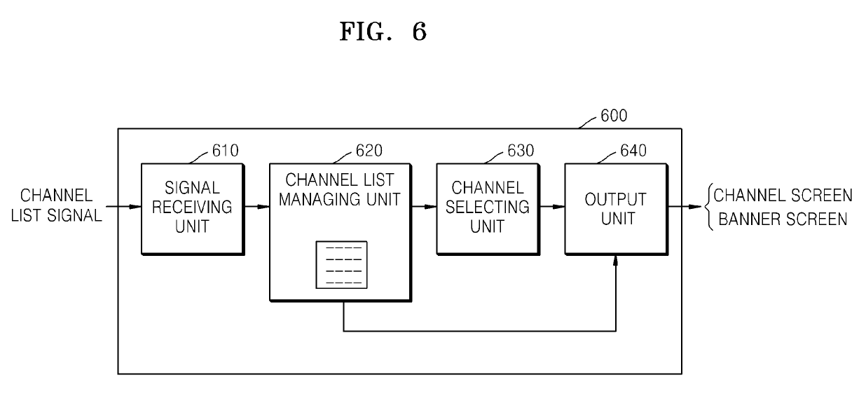

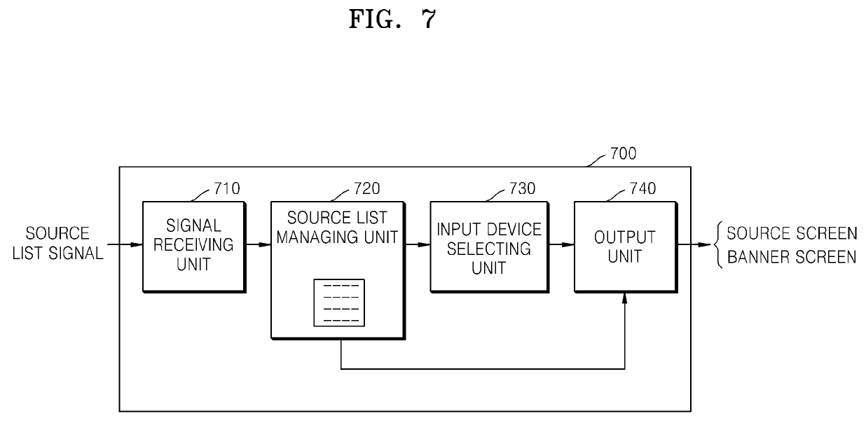

FIG. 6 is a functional block diagram of an apparatus 600 for providing a channel list in an image display system, according to an exemplary embodiment of the present invention.

Referring to FIG. 6, the apparatus 600 for providing a channel list in an image display system according to the current exemplary embodiment includes a signal receiving unit 610 which receives a signal mapped to a channel list from an external device, a channel list managing unit 620 which displays a channel list including one or more favorite channels according to the received by the signal receiving unit 610, a channel selecting unit 630 which selects a first channel from the one or more favorite channels displayed in the channel list of the channel list managing unit 620, and an output unit 640 which displays a tuned first screen of the first channel selected by the channel selecting unit 630 and a second screen, wherein additional information about the first channel is displayed in the second screen.

Furthermore, the channel list managing unit 620 may transmit the channel list to the output unit 640 so as to display the stored channel list in a screen, according to a signal for calling up the channel list.

In the apparatus for providing a channel list in an image display system according to the current exemplary embodiment, a screen including additional information of registered channels is displayed in one screen together with the channel list so that a user can navigate several registered channels more conveniently.

FIG. 7 is a functional block diagram of an apparatus 700 for providing a source list in an image display system, according to an exemplary embodiment of the present invention.

Referring to FIG. 7, the apparatus 700 for providing a source list in an image display system according to the current exemplary embodiment includes a signal receiving unit 710 which receives a signal mapped to a source list from an external device, a source list managing unit 720 which displays a source list including one or more input devices connected to the image display system according to the signal received by the signal receiving unit 710, an input device selecting unit 730 which selects a first input device from the one or more input devices displayed in the source list of the source list managing unit 720, and an output unit 740 which displays a tuned first screen of the first input device selected by the input device selecting unit 730 and a second screen, wherein additional information about the first input device is displayed in the second screen.

Furthermore, the source list managing unit 720 may transmit the source list to the output unit 740 so as to display the list related to connected input devices in a screen, according to a signal for calling up the source list.

In the apparatus for providing a source list in an image display system according to the current exemplary embodiment, a screen including additional information of input devices is displayed in one screen together with the source list so that a user can navigate several input devices more conveniently.

The invention can also be embodied as computer readable codes recorded on a computer readable recording medium. The computer readable recording medium is any data storage device that can store data which can be thereafter read by a computer system.

In addition, as described above, the structure of data used in the present invention may be recorded on a computer readable recording medium by using several means.

Examples of the computer readable recording medium include read-only memory (ROM), random-access memory (RAM), CD-ROMs, magnetic tapes, floppy disks, and optical data storage devices.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of providing a channel list in an image display system, the method comprising:
receiving a signal mapped to a channel list from an external device;
displaying the channel list including one or more channels in response to the received signal;
selecting a first channel from the channels included in the channel list; and
displaying a tuned first screen of the selected first channel and a second screen, wherein additional information about the first channel is displayed in the second screen.

2. The method of claim 1, wherein the additional information displayed in the second screen is updated in real-time or periodically from an electronic program guide.

3. The method of claim 2, wherein the displaying the channel list comprises displaying a third screen in which additional information about a second channel that is being currently displayed in the image display system is displayed.

4. The method of claim 3, wherein the channel list is a circular linked list.

5. The method of claim 4, wherein the selecting the first channel comprises selecting the first channel by moving a highlighted portion on the channels included in the channel list.

6. The method of claim 5, wherein the channel list comprises at least one of a channel number and a channel name, and the additional information comprises at least one of a program name, a program running time, and a program description.

7. The method of claim 6, wherein the program running time included in the additional information is indicated in a bar shape.

8. The method of claim 7, wherein a screen of the channel list and the additional information disappears from a screen of the image display system after a predetermined time.

9. A method of providing a source list in an image display system, the method comprising:
receiving a signal mapped to a source list from an external device;
displaying a source list including one or more input devices that are currently connected to an image display system, in response to the received signal;
selecting a first input device from the input devices included in the source list; and
displaying a tuned first screen of the selected first input device and a second screen, wherein additional information about the first input device is displayed in the second screen.

10. The method of claim 9, wherein the additional information displayed in the second screen is updated in real-time or periodically from at least one or more input devices that are currently connected to the image display system.

11. The method of claim 10, wherein the displaying the source list comprises displaying a third screen in which additional information about a second device that is being currently displayed in the image display system is displayed.

12. The method of claim 11, wherein the source list is a circular linked list.

13. The method of claim 12, wherein the selecting the first input device comprises selecting the first input device by moving a highlighted portion on the input devices included in the source list.

14. The method of claim 13, wherein the source list comprises at least one of a connected terminal name and an input device name, and the additional information comprises at least one of a connected terminal name, an input device name, a time at which a plurality of input devices are connected, a resolution of an input device, and a bit rate of an input device.

15. The method of claim 14, wherein a screen of the source list and the additional information disappears from a screen of the image display system after a predetermined time.

16. An apparatus for providing a channel list in an image display system, the apparatus comprising:
a signal receiving unit which receives a signal mapped to a channel list from an external device;
a channel list managing unit which displays the channel list including one or more channels according to the received signal;
a channel selecting unit which selects a first channel from the channels included in the channel list; and
an output unit which displays a tuned first screen of the selected first channel and a second screen, wherein additional information about the first channel is displayed in the second screen.

17. An apparatus for providing a source list in an image display system, the apparatus comprising:
a signal receiving unit which receives a signal mapped to a source list from an external device;
a source list managing unit which displays a source list including one or more input devices that are currently connected to an image display system, in response to the received signal;
an input device selecting unit which selects a first input device from the input devices included in the source list; and
an output unit which displays a tuned first screen of the selected first input device and a second screen, wherein additional information about the first input device is displayed in the second screen.

18. A computer readable recording medium having recorded thereon a program for executing the method of claim 1.

19. A computer readable recording medium having recorded thereon a program for executing the method of claim 9.

20. A method of providing a channel list in an image display system, the method comprising:
displaying a first main screen in which broadcast content a first channel is displayed;
in response to a channel list request input, displaying a first sub screen in which a channel list including a plurality channels is displayed and a second sub screen in which information about the first channel is displayed, wherein the first sub screen and the second sub screen overlap the first main screen;
selecting a second channel from the plurality of channels included in the channel list displayed in the first sub screen; and
in response to the selecting the second channel, displaying a second main screen in which broadcast content of the second channel is displayed and a third sub screen in which information about the second channel is displayed.

21. The method of claim 20, further comprising, if an input operation is not performed for a predetermined time while displaying the second main screen and the third sub screen, displaying only the second main screen.

22. The method of claim 20, wherein the selecting the second channel comprises selecting the first channel by moving a highlighted portion on the plurality of channels included in the channel list.

23. The method of claim 20, wherein the information about the first channel and the information about second channel comprises at least one of a program name, a program running time, and a program description.

24. The method of claim 20, wherein the channel list comprises at least one of channel numbers of the plurality of channels and channel names of the plurality of channels.
